(19) United States
(12) Patent Application Publication
(10) Pub. No.: US 2018/0220698 A1
(43) Pub. Date: Aug. 9, 2018

(54) Method and Device for Applying Identification Features to a Packing Strip in Order to Authenticate the Process Packing, Processed Packing and Packing

(71) Applicant: Boegli-Gravures SA, Marin-Epagnier (CH)

(72) Inventors: Charles Boegli, Marin (CH); Werner Steffen, Stans (CH)

(21) Appl. No.: 15/746,024

(22) PCT Filed: Jul. 25, 2016
(86) PCT No.: PCT/IB2016/054421

§ 371 Date: Jan. 19, 2018

(30) Foreign Application Priority Data
Jul. 23, 2015 (EP) 15178077.2

(51) Int. Cl. A24C 5/60; B31F 1/07; B65B 61/02; A24C 5/38; B65B 19/22; B31B 70/88

(52) U.S. Cl. CPC A24C 5/601; B31F 1/07; B31B 70/88; A24C 5/38; B65B 19/22; B65B 61/025

(57) ABSTRACT

In the method for applying identification features to a packing strip in order to authenticate the processed packing, the packing strip is fed in a packing line to an embossing station, where logos of all kinds and/or codes and/or a satin finish and/or fold lines are embossed at the cycle rate of the packing machine by means of embossing rollers by deforming the packing strip, Identification: features and possibly other features are produced additionally on the packing strip on-line, in the same process step, and synchronously to the cycle rate by material removal by means of a feature setup comprising a laser installation, the packing strip having a thickness of 50 μm to 300 μm. The thus treated packing strip is subsequently further processed. Due to the fact that the feature setup for producing the identification features is provided in addition to the embossing rollers but operates in the same process step, all known embossing rollers can be used, and due to the application of lasers for producing the features, e.g. a consecutive numbering can be produced, thereby ensuring a secure authentication method without the need of changing substantially the embossing station comprising a housing with at least two embossing rolls, or lowering the processing speed.

The present invention relates to a method and a device for applying identification features to a packing strip in order to authenticate the processed packing, according to the preambles of claims 1 and 9, as well as to a packing produced by means of the method, according to claim 13.

There are a very large number of methods for authenticating a multitude of identification features on the most diverse goods and their packages. The present invention relates to a method for applying identification features to a packing strip in order to authenticate the processed packing that is intended for foods, pharmaceutical goods, electronic appliances and in particular tobacco products such as cigarettes or cigars contained in this packing.

The term “strip” has here the meaning that, coming from a feed drum, it is generally guided to a packing installation, for being separated after being processed. The following steps are according to the kind of the goods to be packed.

The packing strip can be for the packing of smoking articles like cigarettes or cigars, foreseen as inner liner which can have a thickness of 30 μm 70 μm and be of plastic material, hybrid as well as metal coated or metal vaporized or plastic coated. It can also be a folding box board, a so-called blank, which has in general a thickness of 300 μm, and is often white or dyed e.g. in grey and may be plain, lacquered, printed and/or laminated with aluminium foil or plastic film. On occasion, the folding box board can have a thickness of about 600 μm. For the packing of food and pharmaceutical products the above mentioned inner liner is also used, or a metal foil of a thickness of about 10 μm to 50 μm or it can be an aluminium laminated inner liner with a weight of 20 g/m² to 90 g/m².

EP 1 867 470 B1 to the applicant of the present invention discloses a method and a device for authenticating identification features that are embossed on a packing foil where on one hand a foil of this kind, more particularly a so-called inner liner used in the tobacco industry, is satinized in addition to embossing identification features, and on the other hand, an array of identification features is embossed as a pattern on-line, read by a suitable apparatus, and compared to a template by means of an image processing method.

The thus defined method is successfully applied for authenticating packing foils which generally have a thickness of 30 to 70 μm and are e.g. used as inner liners, i.e. as packing foils that are wrapped around a number of cigarettes, the wrapped cigarettes being subsequently inserted into a cardboard cigarette packet. In this method, the identification features, generally in the form of point-shaped elements, are transferred onto the embossing rollers according to a defined template, and the foils embossed in this manner are decoded by means of the same template. To this end, optical reading methods and suitable encryption algorithms are applied.

In the period between the first filing of the aforementioned EP 1 867 470 B1 and the present invention, important changes both with respect to the arrangement of identification features, i.e. of codes and with respect to the packing materials have been tested.

It has become apparent, however, that the now existing multitude of codes that can be applied to packages simultaneously, e.g. barcodes or QR codes, may look impressive but ultimately do not ensure a secure authentication as the reproduction possibilities for falsifications have also enormously increased.

The packing materials for tobacco products such as cigarettes and cigars have been subject to continuous changes as well. Packing foils for the food or the tobacco industry have been embossed by means of embossing roller devices fora long time. In the case of tobacco products, the aforementioned inner liners are concerned, which may also serve as a packing material for chocolate, butter, or similar foods, or for electronic components. In parallel to the developments of the embossing roller technology, i.e. the manufacture of the embossing rollers, the packing materials also were subject to changes in that the originally used all-metal aluminium foils were replaced by paper foils whose surfaces were coated with ever thinner metal layers due to environmental considerations and the very thin metal layer was applied by sputtering. In the near future, the metallization of the inner liners will be further reduced or eventually omitted altogether.

Furthermore, efforts are lately being made to strongly restrict or completely eliminate advertising for tobacco products so that it will no longer be possible to emboss the inner liners with promotionally effective designs or with identification features to the former extent. Therefore, possibilities are being sought for producing new decorative effects without using eye-catching embossings, gold rims or decorations of the kind, and also for following new ways in the application of identification features.

At present, a number of the cigarettes are mostly wrapped in an inner liner and placed in a folded box. In most cases, moisture preservation and protection from exterior influences are enhanced by a wrapper made of a plastic film, e.g. a polypropylene film. Neither can the inner liner alone fulfil the desired functions e.g. of keeping the tobacco products moist and protecting them against exterior olfactory influences, on one hand, and of providing a certain stiffness for the mechanical protection of the cigarettes, on the Other hand, nor can the folded box alone. These requirements are currently met by a suitable folding box board material, also called “blank”.

In the exemplary embodiments of the present application reference is made in particular to inner liners, which have in general a thickness of 30 μm to 70 μm. It is expressly pointed out that the methods for applying identification features on inner liners described hereinafter merely represent examples and that the invention also applies to other packings such as packings for the food and pharmaceutical industry including metal foils of a thickness of about 20 μm, or hybrid and laminated as well as metal or plastic coated, or folding box board packings. Moreover, this method can also be used for applying other, e.g. decorative features. Furthermore the packing strip can also be printed or be embossed by a die embossing machine.

It is known that tobacco products are particularly susceptible to counterfeiting, not least in order to evade the high customs duties and taxes. This means that not only the tobacco industry itself, which of course suffers from the resulting damage, but also the customs and tax authorities are interested in determining whether the marketed cigarette packets are authentic.

Methods using the so-called signature of an object in order to verify its authenticity are known in the art, e.g. from GB 2411954 A. Surface sections of objects e.g. of paper have unique physical characteristics. These can be detected by measurements and the resulting data can be processed and subsequently used as a reference, i.e. as an identification feature. In practice, however, it has been found that the measuring and data processing expenditure is justifiable economically only in isolated cases. Furthermore, cellulose-based packing materials are natural products that may be subject to such alterations over time that a meaningful initial reference definition is difficult.

DE 2 746 440 C2 describes a mechanical technique that consists in an embossing operation for marking natural materials. The pressure applied to media such as textile materials, leather or the like and the vacuum technique used in this reference stimulated reflections on how a quasi-fiat embossing might be realized “on the fly” in an on-line process. The part to be embossed is fed to a chamber in which the medium is pressed flat against a lightly perforated band on a short distance by a vacuum. The debossed information is always applied in the same location in a correctly synchronized manner.

In DE102012020153A1, an endless band is used for embossing cards. The term “embossing” is meant to include the application of the most diverse contours to materials such as metals, paper, synthetic materials, leather or the like under the impact of pressure. Such contours are meant to include patterns, signatures, holograms or the like.

In a further development of such endless processes, dot printer matrixes synchronously act upon the flat portion of the medium in the embossing process, thereby allowing to apply changing information. To this end, the medium to be marked is moved on a printing band loop across a flat supporting plate that serves to receive the pressure applied by dot matrix printer modules that are moved along in synchronicity, possibly with an ink ribbon unless only pits are desired. Although modern dot matrix printers can print e.g. 600 characters per second, the result is unsatisfactory due to the high mechanical complexity and the required synchronicity of the rotary movements required for embossing packing material. Therefore, such a mechanical process was not found to be suitable for high-speed on-line embossing.

In the case of the tobacco industry, it would be particularly desirable to upgrade existing embossing stations using embossing rollers in order to apply additional identification features while maintaining the embossing speed that is usual today. Furthermore it would be desirable to integrate suitable devices for producing the identification features into existing packing lines. In contrast to the aforementioned signature principle, only a minimum amount of data should be required for the consecutive identification, e.g. a consecutive numbering. Furthermore the numbering should be achieved by means of arbitrary algorithms, thereby suggesting a random numbering to outsiders.

There is thus a need to be able to continuously provide packages produced in an on-line process with identification features generated in situ without the need of applying prefabricated marks by gluing, injecting or by other means and without the need of reducing the packing speed.

On the background of the prior art and the needs described above, it is the object of the present invention to provide a method and a device for applying identification features to a packing strip in order to authenticate the processed packing that allows embossing signs of all kinds, logos, folding lines, or coded signs through a material deformation by means of embossing rollers and producing identification features providing increased security with regard to the authentication of the packaged good without reducing the speed of the packing machine and modifying essentially the embossing station as well as not altering substantially the embossing station comprising a housing with at least two embossing rolls.

This object is attained by the method according to the independent method claims, and by the device according to the independent device claims. A packing produced according to the independent method claims is defined in corresponding independent claims. Further features and advantages are defined in the further claims.

The invention will be explained in more detail hereinafter with reference to drawings of exemplary embodiments.

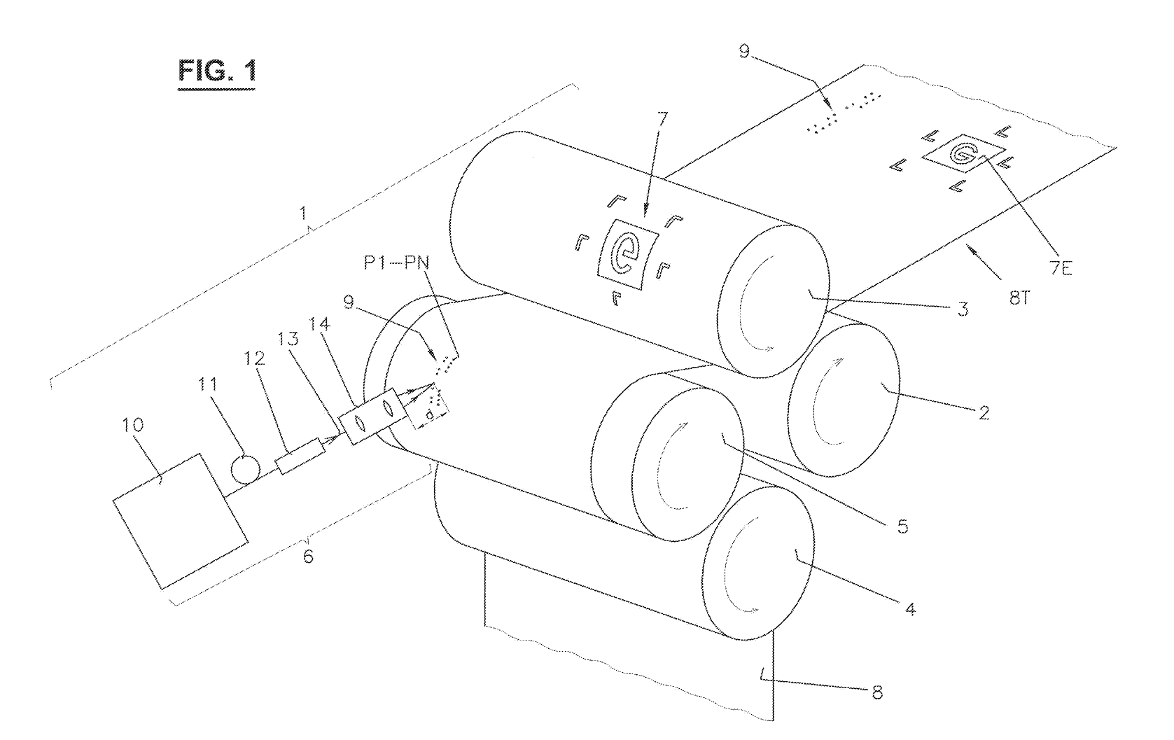

FIG. 1 schematically shows an embossing station with embossing rollers and a device for applying identification features according to the invention,

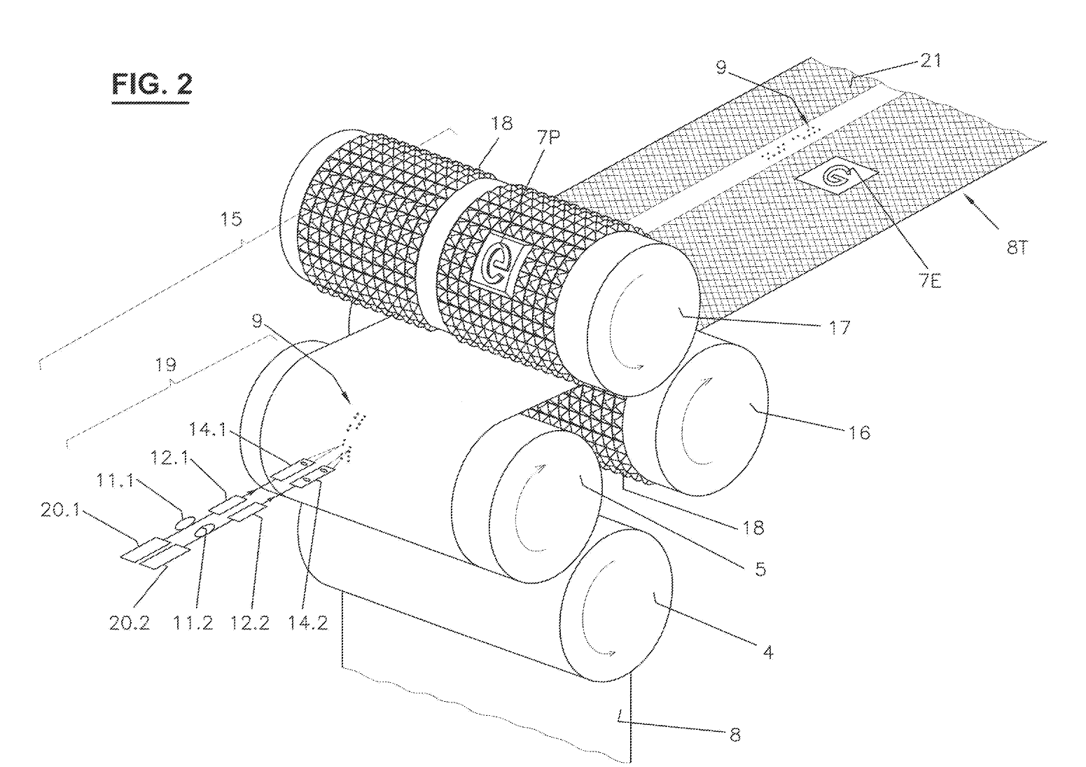

FIG. 2 shows an embodiment variant of FIG. 1,

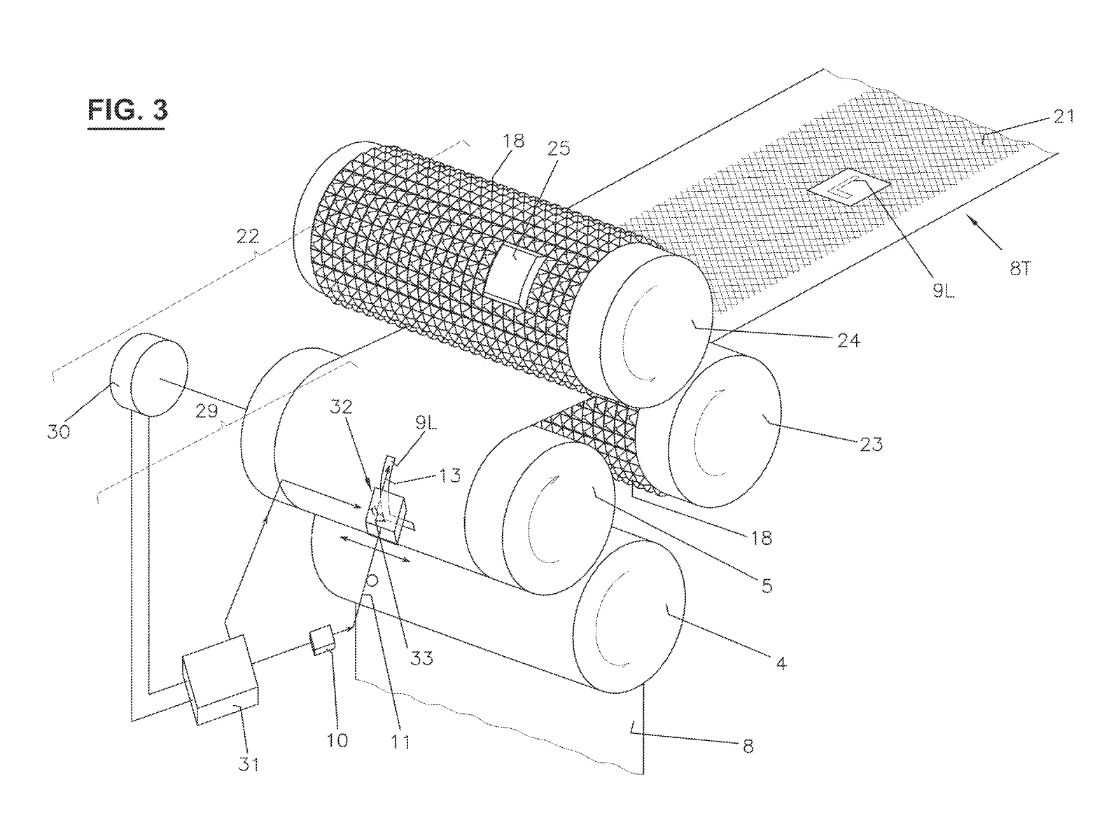

FIG. 3 shows another embodiment variant of FIG. 1,

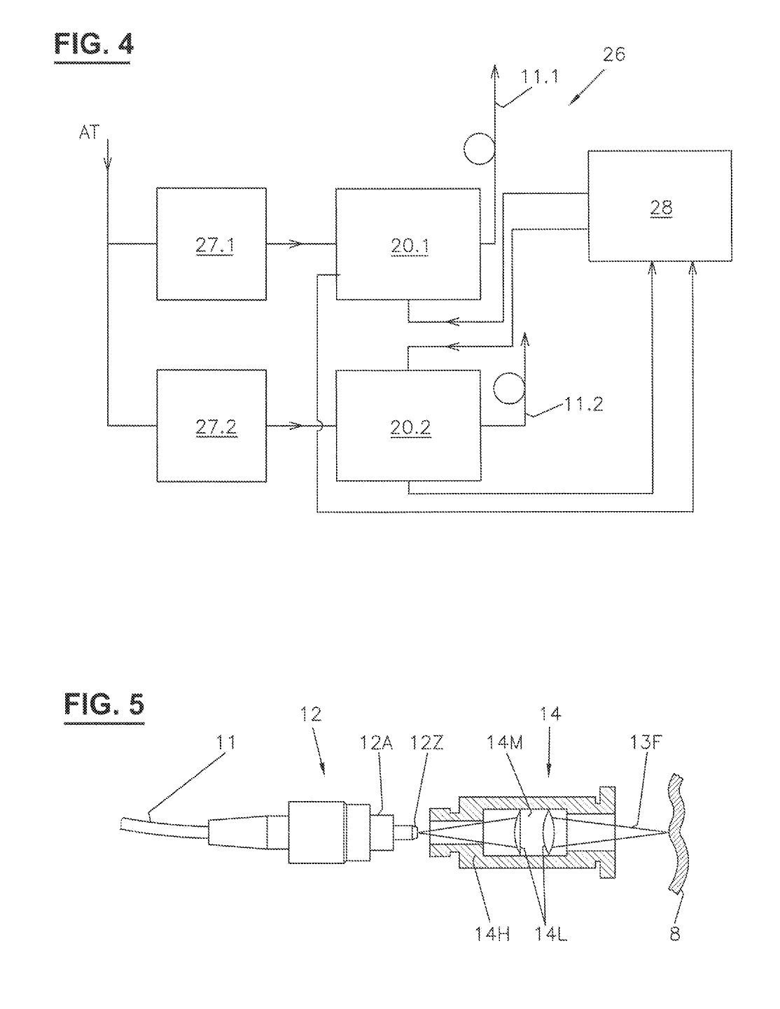

FIG. 4 shows a diagram of the control of the laser installation of FIG. 1,

FIG. 5 shows the optics of the laser installation of FIG. 1 on an enlarged scale and in a partly sectioned view,

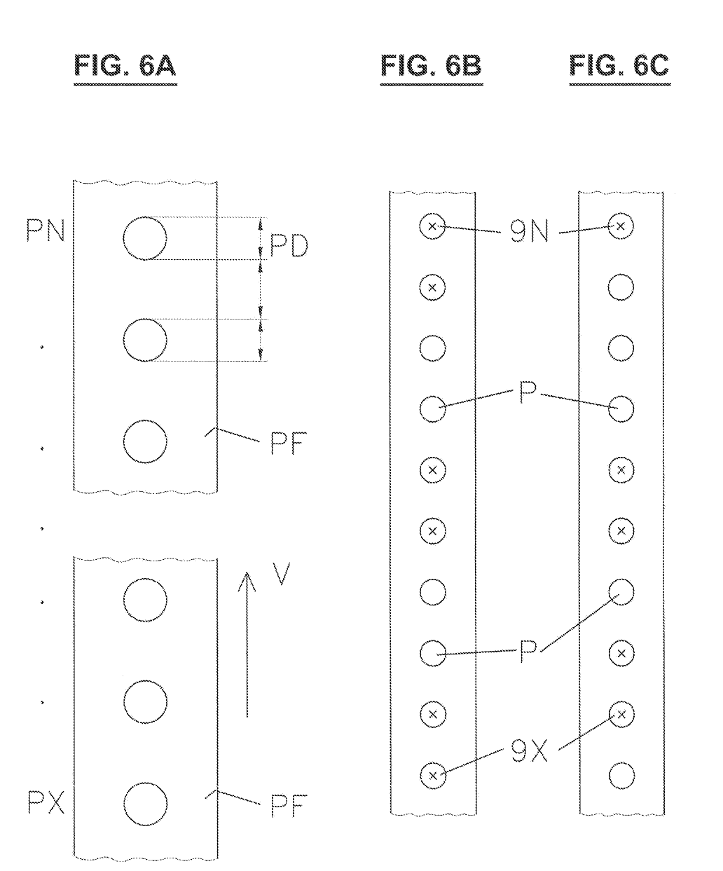

FIG. 6A shows a packing strip with possible positions for producing identification features by means of the device of FIG. 1,

FIGS. 68 and 6C show an example of positions of FIG. 5A occupied by defined indentations,

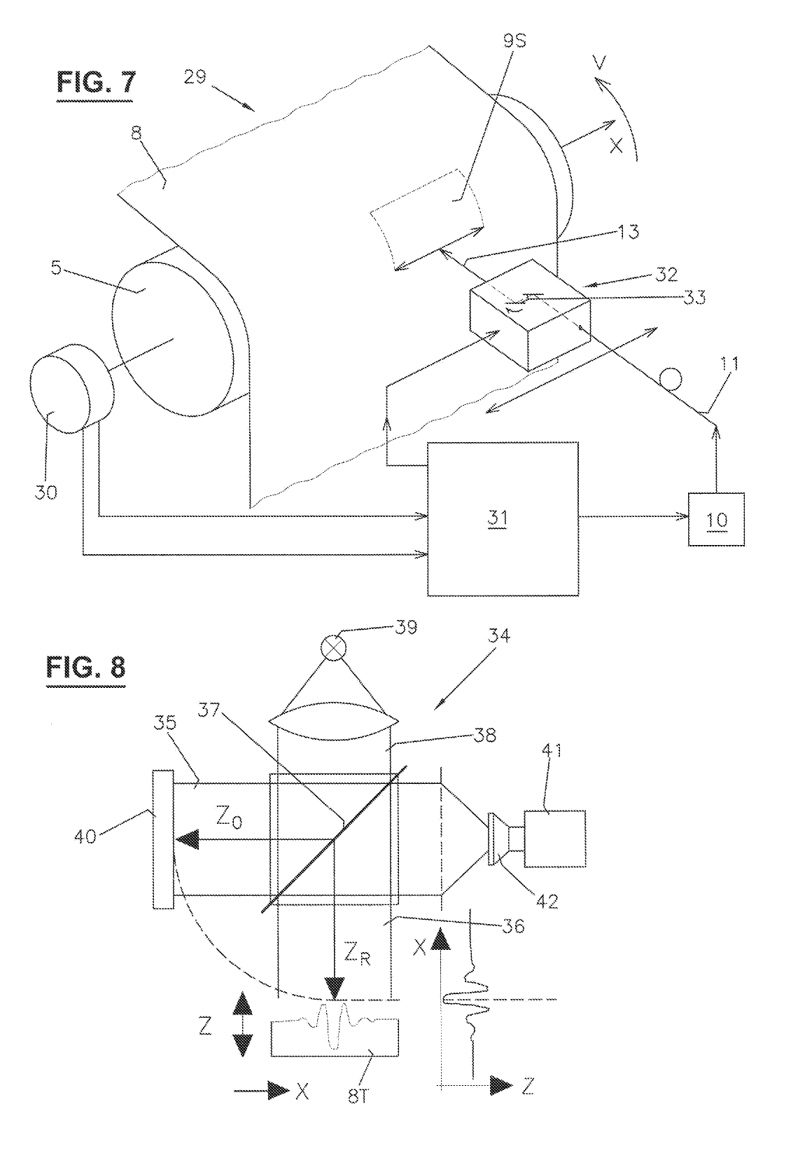

FIG. 7 shows, as an alternative to the exemplary embodiment according to FIGS. 1-5, a feature setup with a scanner head for applying identification features and features, and

FIG. 8 schematically shows a white light interferometer for reading ID features.

According to the general inventive idea, a simple application of identification features providing a high authentication security is performed in an embossing station in addition to ail embossing methods using embossing rollers that are known per as. This is achieved by means of a laser installation by which material is removed from the packing strip in order to form the identification features or briefly ID features or other features. Currently, diode laser installations are found to be suitable for this purpose.

With the term “diode lasers” all kind of lasers are meant, which apply directly the emission of diodes. It is also possible to employ diode pumped solid state lasers, or solid state lasers, whereby the fibre lasers fall under this category. If more material on a surface has to be removed from the packing strip CO₂-laser may be employed.

Laser direct machining of thermoplastics is known in the art. An exemplary technique is the manufacture of printed circuit boards according to a “reverse process”, so to speak. The tracks to be produced are cut out from a substrate covered with a synthetic material and subsequently metallised.

In the paper industry, large embossing rollers with special metallic surfaces are directly machined in 3D by means of lasers, and moreover the industry offers laser machining systems of all kinds for papers and metallised papers, e.g. the company Palegra in Berlin or the company Acsys in Lüdenscheid. Diode fibre lasers are e.g. manufactured by the company IPG Optonics in Burbach, Germany.

Currently, a typical near infrared diode machining laser is able to remove material at 1000 m/sec, i.e. 1 mm per μsec, at a pulse train frequency of 250 kHz, 9 ns pulses, and a power of 40 watts. Glass fibre cables connected to the laser with imaging optics coupled to their other ends allow a precise machining of paper surfaces at nearly arbitrary foci. In the case of natural cardstock of e.9. 170 μm thickness, to engrave the paper, up to ⅔ of its depth can be removed without smoke traces. Special papers such as coated or cast-coated papers require preliminary analyses. One requirement of inner liners or packing foils for the food industry is that they may not be perforated during the treatment.

In the area of production lines in the tobacco industry, speeds of e.g. 100 m/min to 180 m/min are used, resulting in a feed rate of 3 μm per μs in the latter case. A pulse train frequency of 250 kHz theoretically allows a material removal every 4 μsec. However, there exist packing machines working at lower speed of e.g. 60 m/min.

FIG. 1 schematically shows some components of an embossing station 1, which comprises two embossing rollers 2 and 3 contained in a not represented housing, f ex. according to WO 2013156256 A1 to the same applicant. The embossing station comprises additionally a feature setup 6 for the application of ID features. In the present exemplary embodiments are further presented a deflecting roller 4 as well as a guide roller 5, on which the feature setup is acting. For certain applications the deflecting and guiding rollers are not necessary.

The surface of driven roller 3 is provided in a manner known per se with embossing elements 7, the latter including logos of all kinds and/or folding lines and/or further codes such as QR codes or the like. These elements are for example produced according to WO 2013156256 A1 or EP 2511088 to the same applicant. The symbols G and L represent such elements. Since feature setup 6 is provided in addition to the embossing rollers, no restrictions apply to the design of the embossing rollers. In this embodiment the rollers are synchronized by not shown gears or electronically.

Via deflecting roller 4, packing strip 8 reaches guide roller 5, where ID features 9 are applied, and subsequently passes between the two embossing rollers 2 and 3 where embossing elements 7 are embossed. The packing strip may previously have been provided with printing. The processed packing strip 8T provided with embossed elements 7E and ID features 9, subsequently reaches a cigarette packing station where it is separated and wrapped around a number of cigarettes. It follows that the application of the ID features is performed on-line in one process step with the embossing and synchronously to the cycle rate of the packing machine.

Feature setup 6 comprises a diode laser installation. Diode laser 10 is coupled to a glass fibre cable 11 that is connected to a fibre support 12 whose exit is provided with an optical system, see FIG. 5. The laser beam 13 exiting from the fibre support impinges on a focusing optics 14 and is focused onto packing strip 8 in order to produce ID features 9 in determined positions PX to PN by material removal. The letter “d” defines the working distance. As will be explained with reference to FIG. 4, the frequency and the power of diode laser 10 can be controlled to produce coded ID features.

For .one skilled in the art it is apparent that the position of the feature setup, i.e. before or after the embossing rollers, is not important for the treatment but that it is arranged where the space conditions are most suitable.

Embossing rollers 2 and 3 are only shown schematically and in a simplified manner here and stand for the embossing rollers manufactured according to the male-female system as described in EP 2 511 088 to the applicant of the present invention. In particular, such embossing rollers may also be provided with folding tools produced according to the male-female system. The embossed elements 7 shown on embossing roller 3 consist of raised male structures. Alternatively, teeth in the pin-up/pin-up configuration may be provided as they are e.g. described in U.S. Pat. No. 6,176,819 to the applicant of the present invention.

FIG. 2 illustrates a second embossing station 15 comprising embossing rollers 16 and 17 as well as deflecting roller 4 and guide roller 5. The embossing rollers are provided with satinising teeth 18 of the pin up pin up configuration as disclosed f. ex. In U.S. Pat. No. 6,176,819 to the same applicant. The logo 7P in the form of a “G” is arranged on a raised, toothless portion in the form of a raised male structure. Feature setup 19 comprises two diode lasers 20.1 and 20.2 and two focusing optics 14.1 and 14.2 for producing features 9. On the processed packing strip ST, the satinized structure 21 is visible.

The different tooth types are e.g. also illustrated in WO 2009/155720 to the applicant where the teeth and tooth gaps are produced mechanically, whereas in WO 2013156256 Al to the applicant of the present invention, the rollers are produced by laser independently of each other according to the Pater-Mater system. Furthermore, EP 2 511 088 to the applicant discloses embossing rollers that are provided with folding tools produced also according to the Pater-Mater system.

FIG. 3 illustrates another embossing station 22 comprising, similarly to embossing station 15 of FIG. 2, two embossing rollers 23 and 24 as well as deflecting roller 4 and guide roller 5. Teeth 18 may be the same as previously, instead of a logo, the rollers have respective blank spots 25. In this Figure it is symbolically indicated that instead of point-shaped pits, features with larger contours may also be produced on the foil by means of a suitable apparatus.

In the present case, feature a has been produced by means of feature set up 29 according to FIG. 7. In the description of FIG. 7 the feature set up is explained in details. The feature L illustrates that besides the identification features, artistic features, f. ex. reliefs, can also be produced by means of one of the described feature setups. Also, to this end, a different device using other lasers than diode lasers may be used. Correspondingly to driven embossing roller 24, counter-roller 23 is provided with a recessed blank spot that is not visible here.

FIG. 4 illustrates the Control of a laser diode pair. Control unit 26 is supplied With the Cycle rate that is determined by the packing machine and symbolically designated by AT. The production cycle AT acts upon respective delay circuits 27.1 and 27.2 leading to diode lasers 20.1 and 20.2. Connected to the diode lasers are respective glass fibre cables 11.1 and 11.2 leading to the non-represented focusing optics. The control of the removal is achieved via a controlling apparatus 28 acting upon the laser diodes and receiving signals from the latter,

FIG. 5 illustrates the fibre support with the connected focusing optics on an enlarged scale. Glass fibre cable 11 connected to the laser enters fibre support 12 whose exit is provided with a expanding and focusing optics 12Z and 14. Focusing optics 14 is shown in a simplified sectional view, and its housing 14H accommodates a multi-lens system 14M, in this case one with two lenses 14L. The focused laser beam 13F impinges on packing strip 8.

The following assumptions illustrate the theoretical sequence of operations: With an embossing speed of the packing strip of e.g. 12,000 cm/minute as it is usual in the tobacco industry, which corresponds to 2 μm per μsec, each one of feature positions P1-PN is passed in approx. 50 μsec. According to the preset coding, arbitrary ones of the intended feature positions are marked, i.e. pits are produced, see FIGS. 6A-6C. If e.g. two lengths of the inner liner are being embossed on the roller circumference, the same procedure is repeated in a position offset by 180°. Since the removal duration is shorter in on-line operation than in static operation due to the moving medium, this has to be compensated by the power applied within the exposure time of 50 μsec.

In FIGS. 6A-6C it is illustrated successively and on an enlarged scale how different pits are individually produced by control device 26 in the theoretical locations PX to PN, FIG. 6A, which result in ID features 9X to 9N, see FIGS. 6B and 6C. If a corresponding code is used, the ID features can constitute a consecutive numbering. The framed zones represent the theoretical position fields PF in which the features can be produced on the packing strip.

It is possible to produce arbitrary, possibly differently arranged features redundantly on a second strip that is parallel to the first strip. The theoretical number of approx. 2 exp(n₀) possibilities, with n=50 positions on one strip and n₀2×50=100 positions on two strips, is reduced by the choice of the coding algorithm in function of the desired redundancy or readout reliability, respectively. Redundant coding is usual for packages e.g. in order to compensate for damages or local staining of the surface.

If the laser operates instead through a rigidly mounted fibre that serves as the writing head through a unidimensional scanner scanning in the axial direction of the rollers, it is possible due to the simultaneous rotary motion of the guide roller to write on a rectangular surface of e.g. 1.5 cm×1.5 cm. The fixed x adjustment of the scanner head serves to preadjust the head in the correct position relative to the packing strip. In the scanner head, the laser beam is deflected, its deflexion angle being measured and electronically controlled. The simplest method for producing a scanning movement is to vary the orientation of a mirror on which the laser beam is reflected. In a spatial dimension, this may be achieved by a galvanometer drive.

FIG. 7 illustrates such a feature setup 29 for carrying out a two-dimensional material removal. The synchronisation clock ST of guide roller 5 is detected by a receiver 30 and supplied to a scanner control 31. On one hand, this control acts on laser 10 whose output reaches scanner head 32 via glass fibre cable 11 and from there impinges on the packing strip 8 running over guide roller 5. On the other hand, the control ads on scanner head 32 in which deflexion mirrors 33 are arranged in order to deflect laser beam 13 in the longitudinal axis, thereby producing a two-dimensional feature 9L or 9S.

Laser installations using scanners allow an on-line material removal in arbitrary locations to produce individually modified identification features, reliefs, emblems or other decorations on the packing strip. Thus it is e.g. possible to inexpensively produce inner liners with personalised designs, thereby potentially opening up new markets. An exemplary non limiting enumeration of possible visual content of the thus produced features includes relief-like logos, 3D effects, facial profiles, customised logos with section-wise variation possibilities, numbered visual content. OR codes or the like. These features may either be used as identification features also or mixed with the aforementioned identification features, as desired. Depending on the requirements, a visual, an aesthetic or an automated image evaluation for technical purposes will be implemented.

As a method for reading ID features 9, 9X or features 9L, 9S, e.g. the so-called white light interferometry can advantageously be used. The white light interferometry method uses the interferences of broadband light which, in contrast to laser light, has a short coherence length.

FIG. 8 schematically illustrates a white light interferometer 34 that allows reading and decoding the ID features. Interferometer 34 has two perpendicularly arranged arms 35 and 26 through which the beam 38 from white light source 39 that is separated by the semipermeable mirror 37 is passing, as indicated by the axes Zₒ and Z_{R}. Beam Zₒ reflected by mirror 37 is reflected back by reference mirror 40 onto itself and onto camera 41, whereas the through-going beam Z_{R} is reflected by the foil 8T being measured and is also reflected by semipermeable mirror 37 onto camera 41. Interferences result when the length difference between the reference mirror and the foil surface is smaller than the coherence length. The resulting interference pattern is recorded by camera 41.

By moving the object to be measured along the x-axis at each position a map of the heights is taken for each pixel, which precision lies in the sub-micron region. It is thus possible to create a two or three dimensional topography of the object to be measured.

In this manner, the individual identification features 9, 9X or features 9L or 9S can be detected with utmost precision and decoded by means of suitable software.

Rather than by optical means, it may also be contemplated to read the features by other methods, e.g. by micro x-ray devices or by means of terahertz radiation, e.g. in the 300 GHz to 3 THz range, through the package. Terahertz radiation penetrates many materials such as paper or plastics as well as organic tissue, but has no ionizing effect because of the low photon energy in the range of few milli electron volts.

1-29. (canceled)

30. A method for applying identification features to a packing strip for authenticating a processed packing that includes the packing strip, the packing strip having a thickness of 20 μm to 600 μm, the method comprising the steps of:
feeding the packing strip to an embossing station in a packing line;
embossing at least one of logos and codes into the packing strip, in a process step having a cycle rate;
on line producing an identification feature, in the process step and synchronously to the cycle rate, by material removal from the packing strip, the material removal including applying a feature setup with a laser installation; and
processing the on line produced packing strip after the on line producing.

31. The method of claim 30, wherein a speed of the packing strip is higher than 100 m/minute and the packing strip is configured for at least one of packing of smoking articles, food articles, and pharmaceutical products, the packing strip including at least one of a plastic material, hybrid, metal coated or laminated or plastic coated, and a metal foil.

32. The method of claim 30, wherein the laser installation includes a diode laser.

33. The method of claim 32, further comprising the step of:
connecting an output of the diode laser via a glass fiber cable to a beam expanding and focusing optics to produce identification features as defined pits under control of a control unit.

34. The method of claim 32, further comprising the step of:
connecting an output of the diode laser via a glass fiber cable to a scanner head to produce area-wide identification features.

35. The method of claim 30, further comprising the step of:
reading and decoding the identification features on the packing strip by a white light interferometer.

36. The method of claim 30, further comprising the step of:
producing the identification features and further features in locations of the packing strip where at least one of no teeth and no logos are provided by the embossing rollers.

37. The method of claim 30, further comprising the step of:
producing the identification features and further features in locations of the packing strip where at least one of teeth and logos are provided by the embossing rollers.

38. The method of claim 30, further comprising the step of:
applying at least one of a satin finish and fold lines to the packing strip with embossing rollers by deforming the packing strip.

39. A device for performing a method of providing identification features to a packing strip for authentication of the packing strip, the device comprising:
an embossing station including embossing rollers, deflecting rollers, a guide roller arranged for guiding the packing foil, and a feature setup,
wherein the feature setup is configured to apply the identification features, and
wherein the feature setup includes a laser installation configured to and controlled to operate at a cycle rate of a packing machine and in a same process step as a step of embossing logos and codes into the packing strip.

40. The device of claim 39, wherein the laser installation includes a diode laser having an output that is coupled to a glass fiber cable whose exit is coupled to a rigid focusing optic to produce at least one of the identification features and further features.

41. The device of claim 39, wherein the laser installation includes a diode laser having an output that is coupled to a glass fiber cable whose exit is coupled to a feature setup with a scanner head to at least one of the identification features and further features.

42. The device of claim 39, wherein the embossing rollers include at least one of:
teeth for at least one of satinizing and producing logos;
raised and associated recessed structures that are produced independently of each other according to a male-female system for producing codes; and
folding tools.

43. The device of claim 39, wherein the deflecting rollers and the guide roller is configured to guide the packing band relative to the feature setup.

44. A processed packing comprising:
a packing strip produced according to claim 30, the packing strip configured for at least one of packing of smoking articles, food articles, and pharmaceutical products, the packing strip including at least one of a plastic material, hybrid, metal coated or laminated or plastic coated, and a metal foil,
wherein the processed packing is provided with embossed signs and with identification features produced by material removal in a form of at least one of pits and larger features.

45. A method for applying identification features to a packing strip to authenticate the processed packing, comprising the steps of:
feeding the packing strip in a packing line to an embossing station; and
embossing the packing strip at the embossing station to create at least one of logos, codes, satin finish, and fold lines by embossing rollers by deforming the packing strip,
wherein the identification features are produced on-line in a same process step and synchronously to a cycle rate by material removal from the packing strip by a feature setup including a laser installation, the packing strip having a thickness of 20 μm to 600 μm.

46. The method according to claim 45, wherein a speed of the packing strip is higher than 100 m/minute, and the packing strip is configured for at least one of packing of smoking articles, food articles, and pharmaceutical products, the packing strip including at least one of a plastic material, hybrid, metal coated or laminated or plastic coated, and a metal foil.

47. The method according to claim 45, wherein the laser installation includes a diode laser.

48. The method according to claim 47, wherein an output of the diode laser is connected via a glass fiber cable to a beam expanding and focusing optics to produce identification features in a form of defined pits under control of a control unit.

49. The method according to claim 47, wherein an output of the diode laser is connected via a glass fiber cable to a scanner head to produce area-wide identification features.

50. The method according to claim 45, further comprising the step of:
reading and decoding at least one of the identification features and further features on the treated packing foil by a white light interferometer.

51. The method according to claim 45, wherein at least one of the identification features and further features are produced in locations where at least one of no teeth and no logos are provided on the embossing rollers.

52. The method according to claim 45, wherein at least one of the identification features and further features are produced in locations where at least one of teeth and logos are provided on the embossing rollers.

53. A device for implementing a method for applying identification features and further features to a packing strip to authenticate the processed packing strip, the device comprising:
an embossing station including embossing rollers, deflecting rollers, a guide roller for guiding the packing foil, and a feature setup for applying at least one of identification features and further features,
wherein the feature setup includes a laser installation configured to operate at the cycle rate of the packing machine and in a same process step as the step of embossing the packing strip at the embossing station.

54. The device according to claim 53, wherein the laser installation includes a diode laser having an output that is coupled to a glass fiber cable whose exit is coupled to a rigid focusing optic to produce at least one of the identification features and further features.

55. The device according to claim 53, wherein the laser installation includes a diode laser having an output that is coupled to a glass fiber cable whose exit is coupled to a feature setup with a scanner head to produce at least one of the identification features and further features.

56. The device according to claim 53, wherein the embossing rollers include at least one of:
teeth for at least one of satinizing and producing logos;
raised and associated recessed structures that are produced independently of each other according to a male-female system for producing codes; and
folding tools.

57. The device according to claim 53, wherein the deflecting rollers and the guide roller are configured to guide the packing band relative to the feature setup.

58. A packing produced according to claim 45, wherein the packing strip is configured for at least one of packing of smoking articles, food articles, and pharmaceutical products, the packing strip including at least one of a plastic material, hybrid, metal coated or laminated or plastic coated, and a metal foil, and
wherein the packing is provided with embossed signs and with identification features produced by material removal in a form of at least one of pits and larger features.
